(19) United States
(12) Patent Application Publication
(10) Pub. No.: US 2025/0156775 A1
(43) Pub. Date: May 15, 2025

(54) CHANGE RATE EXPLORATION SYSTEM

(71) Applicant: NTT DOCOMO, INC., Tokyo (JP)

(72) Inventors: Yusuke NAKAMURA, Chiyoda-ku (JP); Takashi SUZUKI, Chiyoda-ku (JP); Akira YAMADA, Chiyoda-ku (JP)

(73) Assignee: NTT DOCOMO, INC., Tokyo (JP)

(21) Appl. No.: 18/837,704

(22) PCT Filed: Feb. 8, 2023
(86) PCT No.: PCT/JP2023/004235

§ 371 Date: Aug. 12, 2024

(30) Foreign Application Priority Data
Apr. 18, 2022 (JP) 2022-068124

(51) Int. Cl. G06Q 10/04; G06Q 50/40

(52) U.S. Cl. CPC G06Q 10/04; G06Q 50/40

(57) ABSTRACT

A change rate search system is a system that searches for a change rate, which is a rate at which people change their behavior in response to predetermined measures, to make the degree of congestion in the people's behavior area desirable under predetermined criteria, and includes: a simulation unit that sets a change rate for predetermined measures and simulates people's behavior when the predetermined measures are taken in a behavior area by using the set change rate; and a search unit that searches for a desirable change rate based on the degree of congestion obtained from simulation results by the simulation unit.

### TECHNICAL FIELD

The present invention relates to a change rate search system that searches for a change rate, which is a rate at which people change their behavior in response to predetermined measures, to make the degree of congestion in the people's behavior area desirable under predetermined criteria.

### BACKGROUND ART

Patent Literature 1 shows that customers are guided to level out the density of customers in the stores by providing the customers who tend to purchase products in stores that are expected to be crowded with recommended store visit information with the store visit tendencies of the customers partially changed.

### CITATION LIST

### Patent Literature

Patent Literature 1: Japanese Unexamined Patent Publication No. 2008-204370

### SUMMARY OF INVENTION

### Technical Problem

Conventionally, as shown in Patent Literature 1, measures to reduce congestion by changing people's behavior have been proposed. However, when measures to reduce congestion are taken, there is a risk that more people than expected will change their behavior, resulting in other times or places becoming more crowded, which may be counterproductive.

An embodiment of the present invention has been made in consideration of the above, and it is an object of the present invention to provide a change rate search system capable of searching for a change rate, which is a rate at which people change their behavior in response to predetermined measures, to make the degree of congestion in the people's behavior area desirable under predetermined criteria.

### Solution to Problem

In order to achieve the aforementioned object, a change rate search system according to an embodiment of the present invention is a change rate search system for searching for a change rate, which is a rate at which people change their behavior in response to predetermined measures, to make a degree of congestion in a people's behavior area desirable under predetermined criteria, and includes: a simulation unit that sets a change rate for predetermined measures and simulates people's behavior when the predetermined measures are taken in a behavior area by using the set change rate; and a search unit that searches for a desirable change rate based on a degree of congestion obtained from simulation results by the simulation unit.

In the change rate search system according to an embodiment of the present invention, a change rate for predetermined measures is set, people's behavior when the predetermined measures are taken in the behavior area is simulated, and a desirable change rate is searched based on the degree of congestion obtained from the simulation results. Therefore, according to the change rate search system according to an embodiment of the present invention, it is possible to search for the change rate, which is a rate at which people change their behavior in response to predetermined measures, to make the degree of congestion in the people's behavior area desirable under predetermined criteria.

### Advantageous Effects of Invention

According to an embodiment of the present invention, it is possible to search for a change rate, which is a rate at which people change their behavior in response to predetermined measures, to make the degree of congestion in the people's behavior area desirable under predetermined criteria.

### BRIEF DESCRIPTION OF DRAWINGS

FIG. 1 is a diagram showing the configuration of a change rate search system according to an embodiment of the present invention.

FIG. 2 is a diagram schematically showing a multi-agent simulation.

FIG. 3 is a table showing an example of information on simulation target people, which is information necessary for a simulation.

FIG. 4 is a table showing an example of information indicating the conditions of measures, which is information necessary for a simulation.

FIG. 5 is a table showing an example of information indicating the degree of congestion obtained as simulation results.

FIG. 6 is a graph showing an example of the relationship between a behavior change rate and an evaluation function value.

FIG. 7 is a table showing examples of a calculated evaluation function value.

FIG. 8 is a flowchart showing a process performed by the change rate search system according to the embodiment of the present invention.

FIG. 9 is a diagram showing the hardware configuration of the change rate search system according to the embodiment of the present invention.

### DESCRIPTION OF EMBODIMENTS

Hereinafter, an embodiment of a change rate search system according to the present invention will be described in detail with reference to the diagrams. In addition, in the description of the diagrams, the same elements are denoted by the same reference numerals, and repeated description thereof will be omitted.

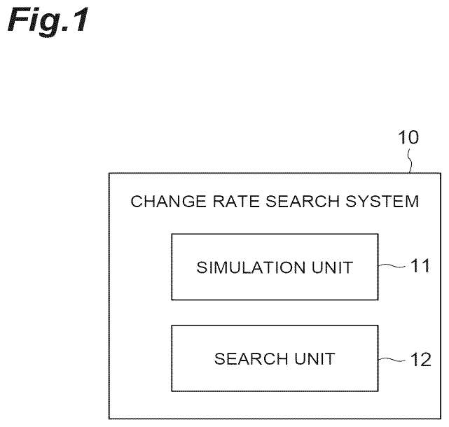

FIG. 1 shows a change rate search system 10 according to the present embodiment. The change rate search system 10 is a system (apparatus) that searches for a change rate, which is a rate at which people change their behavior in response to predetermined measures, to make the degree of congestion in the people's behavior area desirable under predetermined criteria.

The change rate search system 10 is premised on measures to reduce congestion in the people's behavior area. In the present embodiment, measures are intended to reduce the congestion of passengers in a transportation means (for example, public transportation means such as buses). However, the target of congestion reduction does not necessarily have to be a transportation means, and may be the geographical location of a facility or the like.

Measures are to change people's behavior. In the present embodiment, a change in person's behavior in response to measures is called a behavior change. For example, the measures are to change the destination of a person who acts. By changing the destination of the person who acts, it is possible to affect the degree of congestion in a transportation means. In addition, the measures are not necessarily limited to those described above as long as the measures change people's behavior. For example, measures to have a person waiting at a bus stop let a bus pass or measures to have the person change the route to their destination may be applied.

Measures are taken, for example, by providing information to those who are acting. Specifically, the measures are to transmit information related to the measures (for example, advertising information for facilities set in advance or information to provide detour directions) to terminals carried by people in a predetermined area. Alternatively, the measures are to display information related to the measures on a digital signage that is installed in a specific location in advance. By seeing this information, a person who acts changes their behavior.

It is expected that congestion in a specific target (for example, a specific bus) will be reduced by taking the above-described measures. However, when such measures are taken, there is a risk that more people than expected will change their behavior, resulting in other times or places becoming more crowded. For example, if all people who receive measures change their behavior, a target corresponding to the destination changed by the measures (for example, the destination itself or transportation means to get to the destination) may become crowded. Therefore, in order for measures to reduce congestion in the behavior area of people, including those who are not the targets of the measures, the change rate (behavior change rate), which is a rate at which people who receive the measures change their behavior, needs to be appropriate.

Conventionally, which congestion situation will occur when measures are taken is calculated based on past experience or know-how. However, such a calculation may not necessarily lead to a desirable congestion state. As described above, the change rate search system 10 searches for a people's behavior change rate resulting from measures to make the degree of congestion in the people's behavior area desirable under predetermined criteria (called an optimal behavior change rate in the present embodiment). Therefore, the degree of congestion and measures targeted by the change rate search system 10 are generally based on future assumptions. In addition, although it is called an optimal behavior change rate in the present embodiment, it does not necessarily have to be strictly optimal, and may be desirable one under predetermined criteria.

The optimal behavior change rate searched for by the change rate search system 10 is used as a reference when taking measures to reduce actual congestion. For example, when reducing actual congestion, measures are taken to achieve the optimal behavior change rate searched for by the change rate search system 10. For example, when the optimal behavior change rate is high (that is, when a high behavior change rate is required), the incentive for the measures for those who receive the measures is set high. When the optimal behavior change rate is low (that is, when a low behavior change rate is required), the incentive for the measures for those who receive the measures is set low or no incentive is set. In this manner, the user of the change rate search system 10, who is a designer of measures, can consider dynamic measures by using the change rate search system 10.

The change rate search system 10 is configured by a computer such as a PC (personal computer) or a server device. The change rate search system 10 may be configured by a plurality of computers. The change rate search system 10 may be able to transmit and receive information to and from other devices through a network in order to acquire information necessary to realize functions.

Subsequently, the functions of the change rate search system 10 according to the present embodiment will be described. As shown in FIG. 1, the change rate search system 10 includes a simulation unit 11 and a search unit 12.

The simulation unit 11 is a functional unit that sets a change rate for predetermined measures and simulates people's behavior when the predetermined measures are taken in the behavior area by using the set change rate. The simulation unit 11 may simulate the behavior of each person who changes their behavior at the set change rate when the measures are received. The simulation unit 11 may acquire information indicating a range in which the predetermined measures are taken and simulate people's behavior when the predetermined measures are taken in the range. The simulation unit 11 may acquire, as information indicating the range in which the predetermined measures are taken, information indicating a geographical range in which measures are taken.

The simulation by the simulation unit 11 is intended to grasp the congestion situation when the measures are taken. For example, the simulation unit 11 performs the simulation as follows.

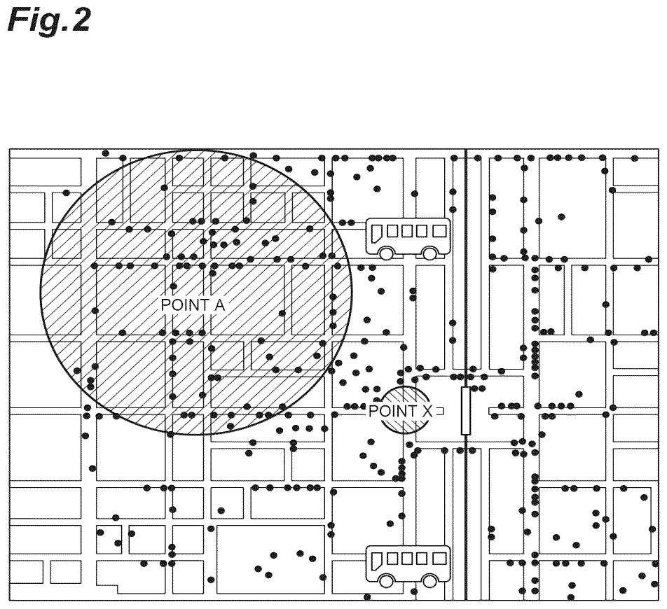

The simulation unit 11 performs a multi-agent simulation in the people's behavior area. The multi-agent simulation is to reproduce the behavior of each person at each time by imitating the real world. FIG. 2 schematically shows a multi-agent simulation. In the multi-agent simulation, the movement status of people (agents) in the people's behavior area, such as an urban area, is calculated. In FIG. 2, each point represents an individual person (person's location). In the multi-agent simulation, a situation in which people use a transportation means such as buses is also calculated.

By using the multi-agent simulation, it is possible to verify the effectiveness of measures in realistic situations (dynamic congestion). In addition, the simulation by the simulation unit 11 does not need to be a multi-agent simulation, and may be any simulation as long as it is possible to simulate people's behavior based on the set behavior change rate when measures are taken.

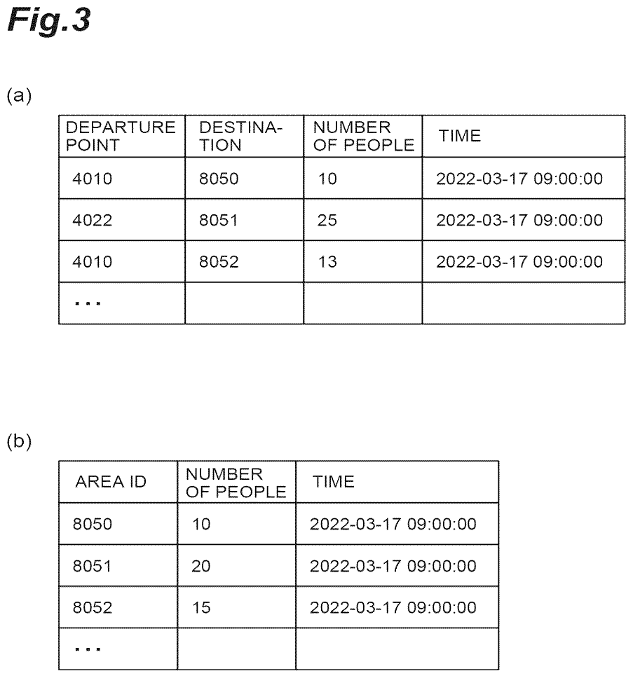

The simulation unit 11 acquires information necessary for the simulation. The simulation unit 11 acquires information on the simulation target person as information necessary for the simulation. Specifically, the simulation unit 11 acquires OD (Origin-Destination) data indicating when, from where, to where, and how many people move. FIG. 3(a) shows an example of the OD data. The OD data is, for example, data in which a departure point, a destination, the number of people, and a time (departure time) are associated with each other. In the example shown in FIG. 3(a), the departure point and the destination of the OD data are identifiers (area IDs) indicating small areas (for example, mesh-shaped areas) where the people's behavior area is divided, which are the departure point and destination. The number of people in the OD data indicates the number of people moving. The time in the OD data indicates the departure time of the movement. Data in the first row of FIG. 3(a) indicates that 10 people depart from a small area “4010” and move to a small area “8050” as a destination starting at 9:00 a.m. on Mar. 17, 2022. In addition, the OD data may also include information (for example, the time of arrival at the destination) other than the above.

The OD data may be generated based on the locations and movements of real people. For example, time-series location information indicating when, where, and how many people are present is obtained from mobile terminals carried by people and various sensors such as sensors that measure traffic volume. FIG. 3(b) shows an example of a location information database that stores this location information. The location information is, for example, information in which an area ID, the number of people, and a time are associated with each other. The area ID of the location information is an identifier indicating a small area (for example, a mesh-shaped area) where the people's behavior area is divided. The number of people and the time of the location information indicate the number of people and the time in the small area indicated by the corresponding area ID. Data in the first row of FIG. 3(b) indicates that 10 people are present in the small area “8050” at 9:00 a.m. on Mar. 17, 2022. The OD data may be generated from the above location information by using known data assimilation techniques.

The simulation unit 11 may read and acquire the OD data from a database in which the OD data is stored in advance, or may generate and acquire the OD data by reading the data from a database in which data with which the OD data can be generated is stored in advance. The simulation unit 11 may acquire the OD data using any other method.

The simulation unit 11 acquires information on the measures for people who act as information necessary for the simulation. The simulation unit 11 acquires information indicating the conditions of the measures as the information on the measures. The conditions of the measures are, for example, information regarding for whom the measures are taken. Specifically, the conditions of the measures are information indicating a range in which the measures are taken. The range in which the measures are taken is, for example, a geographical range in which the measures are taken. In addition, the range in which the measures are taken may be other than the geographical range. For example, the range in which the measures are taken may be a time range.

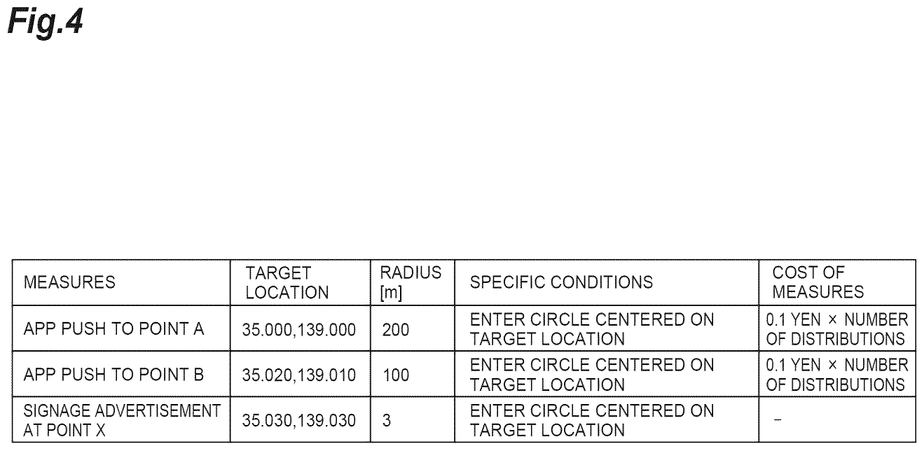

FIG. 4 shows an example of information indicating the conditions of measures. This information is, for example, information in which measures, a target location, a radius [m], specific conditions, and the cost of measures are associated with each other. The measures are information indicating the content of the measures. “App push to point A” indicates that information related to the measures is transmitted to an application on a terminal carried by a person at point A. “Signage advertisement at point X” indicates that information related to the measures is displayed on a digital signage installed at point X.

The target location and the radius [m] indicate a geographical range in which the measures are taken. The area with a radius [m] centered on a location indicated by the target location (for example, the latitude and longitude shown in FIG. 4) is the geographical range in which the measures are taken. FIG. 2 also shows an example of the geographical range. The specific conditions are information indicating the conditions under which a person who acts receives the measures. The cost of measures indicates the monetary cost when the measures are taken. The information on the cost of measures is used by the search unit 12, which will be described later.

The simulation unit 11 may read and acquire the information on the measures from a database in which the information on the measures is stored in advance, or may acquire the information on the measures using any other method. The simulation unit 11 may acquire information necessary for the simulation other than the above information, in addition to the above information or instead of the above information.

For example, the simulation unit 11 performs a simulation when one measure is taken. Specifically, a simulation in which each of the plurality of measures shown in FIG. 4 is taken is performed. The simulation unit 11 sets a plurality of different behavior change rates kᵢ for the measures to be taken, and performs a simulation for each behavior change rate kᵢ. i is an index indicating the number of repetitions. The simulation for each behavior change rate kᵢ is performed to search for an optimal behavior change rate kₒₚₜ. The behavior change rate kᵢ is set according to the rules set in advance. For example, the behavior change rate kᵢ is set to values at predetermined intervals as shown below.
kᵢ=0, 0.01, 0.02, 0.03, 0.04, . . . , 0.10, 0.11, . . . , n

The above-described setting of the behavior change rate kᵢ is intended to comprehensively search for the optimal behavior change rate kₒₚₜ(that is, search for the optimal behavior change rate kₒₚₜ by scanning the behavior change rate kᵢ).

In the above, n is the upper limit of the behavior change rate kᵢ. Since the comprehensive search requires calculation costs, n is a value for stopping the search at an appropriate point. For example, in the case of measures such as an advertisement, n is set to approximately 0.2 (20%). In the case of measures expected to result in a large number of behavior changes, such as providing detour directions, n is set to 1.0 (100%).

In addition, the simulation unit 11 may perform a simulation when a plurality of measures are taken. Specifically, a simulation when the plurality of measures shown in FIG. 4 are taken in combination may be performed. In this case, the simulation unit 11 may set a plurality of different behavior change rates kᵢ for the respective measures as described above. In addition, the behavior change rate kᵢ may be set by using a method other than the above as long as the method is used to search for the optimal behavior change rate kₒₚₜ.

The simulation unit 11 performs a simulation using the set behavior change rate kᵢ and the acquired information necessary for the simulation. For example, the simulation may be performed by using existing software for performing a multi-agent simulation. The simulation by the simulation unit 11 is performed so as to obtain the degree of congestion for a plurality of targets (for example, a plurality of buses). The simulation unit 11 outputs information indicating a simulation result for each set behavior change rate kᵢ to the search unit 12. The output information is for searching for the optimal behavior change rate kₒₚₜ, and will be described in detail later.

The search unit 12 is a functional unit that searches for a desirable change rate based on the degree of congestion obtained from the simulation results by the simulation unit 11. The search unit 12 may search for a desirable change rate based on the degree of congestion in a transportation means. The search unit 12 may search for a desirable change rate by using an evaluation function based on the maximum value or the variation of the degrees of congestion for a plurality of targets obtained from the simulation results. The search unit 12 may acquire information indicating the cost of predetermined measures related to the simulation by the simulation unit 11 and search for a desirable change rate based on the cost as well.

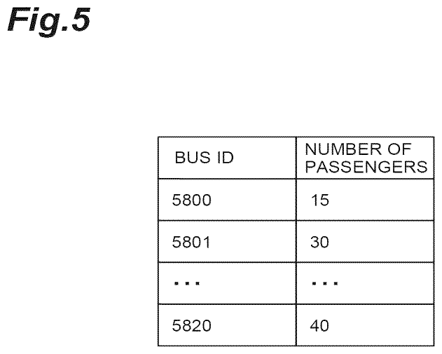

For example, the search unit 12 searches for the optimal behavior change rate as follows. The search unit 12 receives information indicating the simulation result for each behavior change rate kᵢ from the simulation unit 11. The search unit 12 receives, as information indicating the simulation result, for example, information indicating the number of passengers for each of a plurality of buses. For each of the plurality of buses, the search unit 12 determines the number of passengers when the bus passes through a geographical location set in advance in the simulation, which is indicated by the received information, as the degree of congestion for each of the plurality of buses. FIG. 5 shows information indicating the degree of congestion for a plurality of buses. This information is information in which a bus ID and the number of passengers are associated with each other. The bus ID is an identifier indicating a bus. In addition, the target of the degree of congestion does not need to be a bus, which is a transportation means, and may be the location of a facility or the like. In addition, any degree of congestion indicating the degree of congestion in the target may be applied. The degree of congestion does not have to be the number of passengers when passing through a specific location, and may be the number of people at a specific time in the simulation (for example, the end time of the simulation). Alternatively, the degree of congestion may be a time period during which congestion occurs. In addition, the search unit 12 may calculate the degree of congestion from the result of the simulation unit 11 according to the calculation rules set in advance.

In addition, the search unit 12 calculates the cost of measures in the simulation for each behavior change rate kᵢ. For example, the cost of measures is calculated based on information on the cost of measures among the conditions of the measures shown in FIG. 4. The search unit 12 calculates the cost of the measures by referring to not only the information on the cost of measures but also information for calculation among the results of the simulation. For example, the cost of measures of “app push to location A” is the number of distributions (that is, the number of measures taken for people who act)×0.1 yen. The search unit 12 calculates the cost by counting the number of measures taken in the simulation.

The search unit 12 calculates a score, which is an evaluation function value, from the above-described degree of congestion and cost for each behavior change rate kᵢ, using an evaluation function f stored in advance. For example, the evaluation function f is expressed as the following Equation.

f=wₘₐₓM+wᵥₐᵣv+w_{cost}x

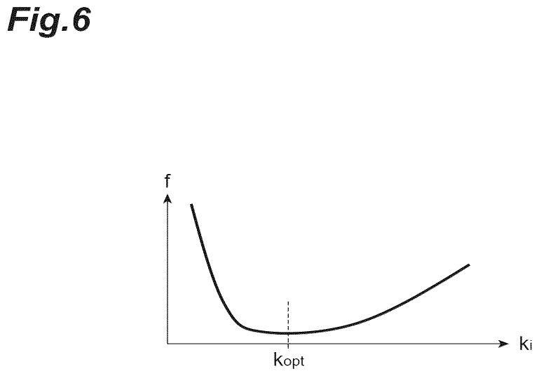

In the above Equation, M is the maximum value of the degrees of congestion for a plurality of buses. v is the variance of the degrees of congestion for a plurality of buses. x is the cost of measures. wₘₐₓ, wᵥₐᵣ, and w_{cost} are weights for the respective values, and are positive values set in advance. It is desirable that the degree of congestion as a result of the measures has a small maximum value and a small variation (for example, the variance described above). This is the criteria indicating the desirability of the degree of congestion. In addition, the criteria indicating the desirability of the degree of congestion do not have to be the above, and may be any criteria. For example, it may be desirable to have a high degree of congestion. In addition, it is desirable that the cost of the measures is small. Therefore, the smaller the evaluation function value, the more desirable the degree of congestion and the cost become for the behavior change rate kᵢ. FIG. 6 shows an example of the relationship between the behavior change rate kᵢ and the evaluation function value (evaluation function f).

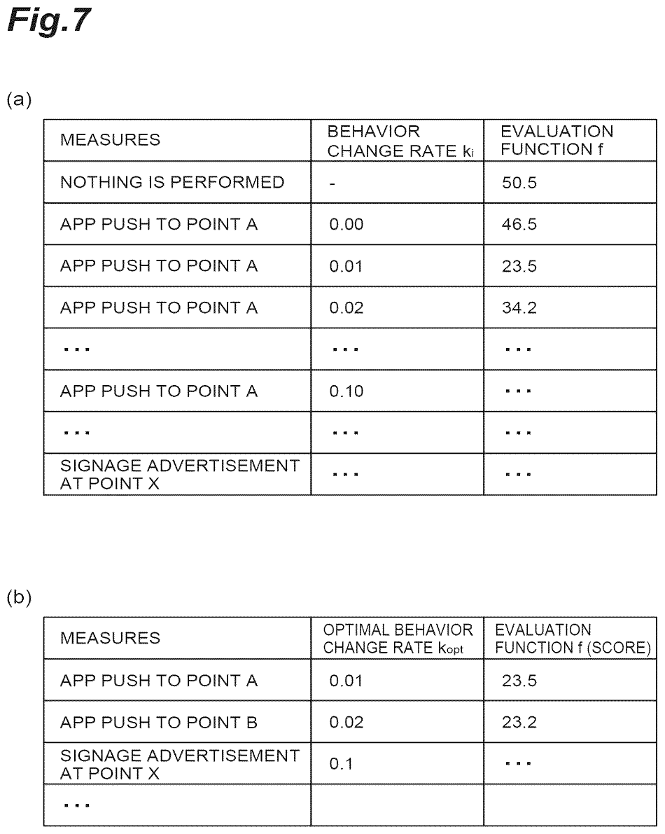

The search unit 12 determines the behavior change rate kᵢ that minimizes the evaluation function value as the optimal behavior change rate kₒₚₜ. The search for the optimal behavior change rate kₒₚₜ is performed for each measure or combination of measures. FIG. 7(a) shows an example of the evaluation function value (evaluation function f) calculated from the results of a simulation for each measure and behavior change rate kᵢ. In addition, FIG. 7(b) shows the optimal behavior change rate kₒₚₜ determined from the evaluation function value in FIG. 7(a).

The search for the optimal behavior change rate kₒₚₜ may be performed in a method other than those described above. For example, in the above, the behavior change rate kᵢ used in the simulation is a comprehensive value, but the optimal behavior change rate kₒₚₜ may be searched for using an existing optimization method that optimizes the evaluation function value with the behavior change rate kᵢ as a variable.

In addition, the equation for the evaluation function f does not necessarily have to be the above Equation, and any Equation that at least searches for the optimal behavior change rate kₒₚₜ based on the degree of congestion obtained from the results of the simulation by the simulation unit 11. In addition, the optimal behavior change rate kₒₚₜ may be searched for by using search criteria other than the evaluation function f.

The search unit 12 outputs information indicating the search result for the optimal behavior change rate kₒₚₜ, for example, information shown in FIG. 7(b). For example, the search unit 12 may display the information on a display device provided in the change rate search system 10 so that the user of the change rate search system 10, who is a designer of measures, can refer to the information. Alternatively, the search unit 12 may transmit the information to another device. In addition, the search unit 12 may output the information in a method other than the above. The above is the function of the change rate search system 10 according to the present embodiment.

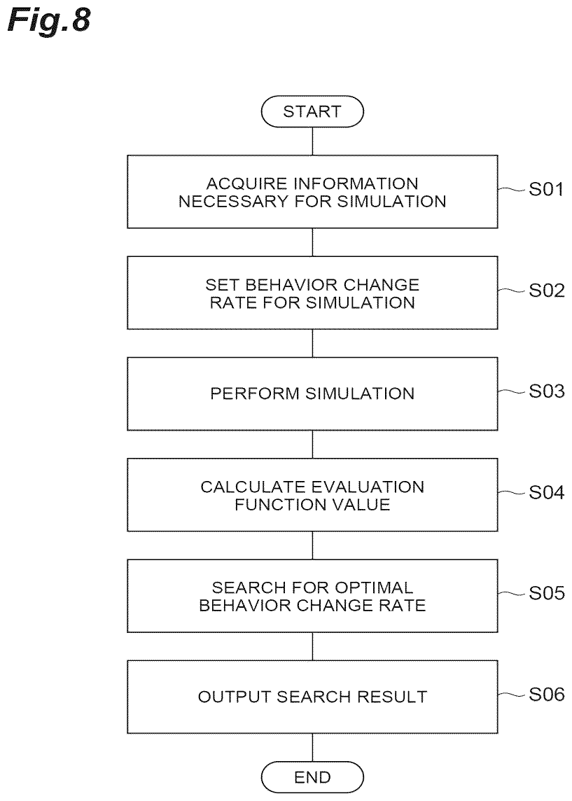

Subsequently, a process performed by the change rate search system 10 according to the present embodiment (a method of an operation performed by the change rate search system 10) will be described with reference to the flowchart of FIG. 8. In this process, first, the simulation unit 11 acquires information necessary for the simulation (S01). In addition, the simulation unit 11 sets the behavior change rate kᵢ for the simulation (S02). Then, the simulation unit 11 performs a simulation of people's behavior when measures are taken in the behavior area by using the acquired information and the set behavior change rate kᵢ (S03). The simulation is performed for each set behavior change rate kᵢ.

Then, the search unit 12 calculates an evaluation function value based on the degree of congestion obtained from the simulation results (S04). Then, the search unit 12 searches for the optimal behavior change rate kₒₚₜ based on the evaluation function value (S05). Then, the search unit 12 outputs information on the search results for the optimal behavior change rate kₒₚₜ (S06). The above is the process performed by the change rate search system 10 according to the present embodiment.

In the present embodiment, the behavior change rate kᵢ, that is the rate of change for predetermined measures is set, people's behavior when the predetermined measures are taken in the behavior area is simulated, and the optimal behavior change rate kₒₚₜ that is a desirable change rate is searched for based on the degree of congestion obtained from the simulation results. Therefore, according to the present embodiment, it is possible to search for the optimal behavior change rate kₒₚₜ that makes the degree of congestion in the people's behavior area desirable under predetermined criteria. As a result, it is possible to take measures to appropriately reduce congestion.

In addition, the optimal behavior change rate kₒₚₜ may be searched for based on the degree of congestion in a transportation means such as buses as in the present embodiment. According to this configuration, it is possible to search for the optimal behavior change rate kₒₚₜ that makes the degree of congestion in a transportation means such as buses desirable under predetermined criteria. However, the target of the degree of congestion used to search for the optimal behavior change rate kₒₚₜ does not have to be a transportation means, and may be, for example, the location of a facility or the like.

In addition, as in the present embodiment, the optimal behavior change rate kₒₚₜ may be searched for using an evaluation function based on the maximum value or variation of the degrees of congestion for a plurality of targets obtained from the simulation results. According to this configuration, it is possible to search for the optimal behavior change rate kₒₚₜ based on appropriate criteria.

In addition, as in the present embodiment, it is possible to acquire information indicating the cost of predetermined measures related to the simulation and search for the optimal behavior change rate kₒₚₜ based on the cost. According to this configuration, it is possible to search for the optimal behavior change rate kₒₚₜ according to criteria that also takes cost, that is, cost-effectiveness into account. However, the search for the optimal behavior change rate kₒₚₜ does not have to be performed using the above configuration, and may be performed based on the degree of congestion obtained from the results of a simulation.

In addition, as in the present embodiment, it is possible to simulate the behavior of each person who changes their behavior at the set change rate when the measures are received. For example, a multi-agent simulation may be performed as described above. According to this configuration, an appropriate simulation can be performed, and as a result, the appropriate optimal behavior change rate kₒₚₜ can be searched for. However, the simulation does not necessarily have to be a simulation of the behavior of each person, and any simulation may be performed as long as the degree of congestion is obtained as simulation results.

In addition, as in the present embodiment, information indicating a range in which predetermined measures are taken may be acquired, and people's behavior when the predetermined measures are taken in the range may be simulated. In addition, as the information indicating the range in which the predetermined measures are taken, information indicating the geographical range in which the measures are taken may be acquired. According to this configuration, it is possible to perform a simulation based on actual measures, and as a result, it is possible to search for the appropriate optimal behavior change rate kₒₚₜ. However, the range in which the measures are taken does not necessarily need to be used in the simulation. For example, measures may be taken uniformly for all people who act.

In addition, the block diagrams used in the description of the above embodiment show blocks in functional units. These functional blocks (components) are realized by any combination of at least one of hardware and software. In addition, a method of realizing each functional block is not particularly limited. That is, each functional block may be realized using one physically or logically coupled device, or may be realized by connecting two or more physically or logically separated devices directly or indirectly (for example, using a wired or wireless connection) and using the plurality of devices. Each functional block may be realized by combining the above-described one device or the above-described plurality of devices with software.

Functions include determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

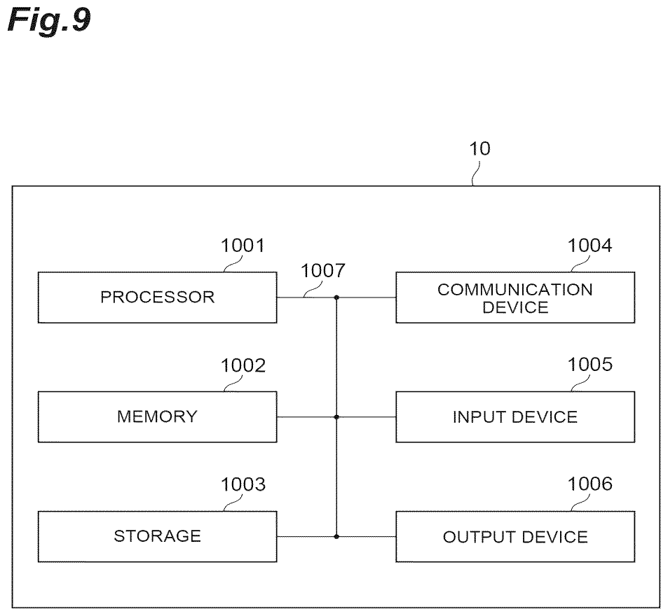

For example, the change rate search system 10 according to an embodiment of the present disclosure may function as a computer that performs information processing of the present disclosure. FIG. 9 is a diagram showing an example of the hardware configuration of the change rate search system 10 according to an embodiment of the present disclosure. The change rate search system 10 described above may be physically configured as a computer device including a processor 1001, a memory 1002, a storage 1003, a communication device 1004, an input device 1005, an output device 1006, a bus 1007, and the like.

In addition, in the following description, the term “device” can be read as a circuit, a unit, and the like. The hardware configuration of the change rate search system 10 may include one or more devices for each of the devices shown in the diagram, or may not include some devices.

Each function in the change rate search system 10 is realized by reading predetermined software (program) onto hardware, such as the processor 1001 and the memory 1002, so that the processor 1001 performs an operation and controlling communication by the communication device 1004 or controlling at least one of reading and writing of data in the memory 1002 and the storage 1003.

The processor 1001 controls the entire computer by operating an operating system, for example. The processor 1001 may be configured by a central processing unit (CPU) including an interface with a peripheral device, a control device, an operation device, a register, and the like. For example, each function in the change rate search system 10 described above may be realized by the processor 1001.

In addition, the processor 1001 reads a program (program code), a software module, data, and the like into the memory 1002 from at least one of the storage 1003 and the communication device 1004, and executes various kinds of processing according to these. As the program, a program causing a computer to execute at least a part of the operation described in the above embodiment is used. For example, each function in the change rate search system 10 may be realized by a control program that is stored in the memory 1002 and operates in the processor 1001. Although it has been described that the various kinds of processes described above are performed by one processor 1001, the various kinds of processes described above may be performed simultaneously or sequentially by two or more processors 1001. The processor 1001 may be implemented by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), and a RAM (Random Access Memory). The memory 1002 may be called a register, a cache, a main memory (main storage device), and the like. The memory 1002 can store a program (program code), a software module, and the like that can be executed to perform the information processing according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (Registered trademark) disk), a smart card, a flash memory (for example, a card, a stick, a key drive), a floppy (registered trademark) disk, and a magnetic strip. The storage 1003 may be called an auxiliary storage device. The storage medium provided in the change rate search system 10 may be, for example, a database including at least one of the memory 1002 and the storage 1003, a server, or other appropriate media.

The communication device 1004 is hardware (transmitting and receiving device) for performing communication between computers through at least one of a wired network and a radio network, and is also referred to as, for example, a network device, a network controller, a network card, and a communication module.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel).

In addition, respective devices, such as the processor 1001 and the memory 1002, are connected to each other by the bus 1007 for communicating information. The bus 1007 may be configured using a single bus, or may be configured using a different bus for each device.

In addition, the change rate search system 10 may include hardware, such as a microprocessor, a digital signal processor (DSP), an ASIC (Application Specific Integrated Circuit), a PLD (Programmable Logic Device), and an FPGA (Field Programmable Gate Array), and some or all of the functional blocks may be realized by the hardware. For example, the processor 1001 may be implemented by using at least one of these hardware components.

In the processing procedure, sequence, flowchart, and the like in each aspect/embodiment described in the present disclosure, the order may be changed as long as there is no contradiction. For example, for the methods described in the present disclosure, elements of various steps are presented using an exemplary order. However, the present invention is not limited to the specific order presented.

Information or the like that is input and output may be stored in a specific place (for example, a memory) or may be managed using a management table. The information or the like that is input and output can be overwritten, updated, or added. The information or the like that is output may be deleted. The information or the like that is input may be transmitted to another device.

The judging may be performed based on a value (0 or 1) expressed by 1 bit, may be performed based on the Boolean value (Boolean: true or false), or may be performed by numerical value comparison (for example, comparison with a predetermined value).

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for illustrative purposes, and has no restrictive meaning to the present disclosure.

Software, regardless of whether this is called software, firmware, middleware, microcode, a hardware description language, or any other name, should be interpreted broadly to mean instructions, instruction sets, codes, code segments, program codes, programs, subprograms, software modules, applications, software applications, software packages, routines, subroutines, objects, executable files, execution threads, procedures, functions, and the like.

In addition, software, instructions, information, and the like may be transmitted and received through a transmission medium. For example, in a case where software is transmitted from a website, a server, or other remote sources using at least one of the wired technology (coaxial cable, optical fiber cable, twisted pair, digital subscriber line (DSL), and the like) and the wireless technology (infrared, microwave, and the like), at least one of the wired technology and the wireless technology is included within the definition of the transmission medium.

The terms “system” and “network” used in the present disclosure are used interchangeably.

In addition, the information, parameters, and the like described in the present disclosure may be expressed using an absolute value, may be expressed using a relative value from a predetermined value, or may be expressed using another corresponding information.

The term “determining” used in the present disclosure may involve a wide variety of operations. For example, “determining” can include considering judging, calculating, computing, processing, deriving, investigating, looking up, searching, inquiring (for example, looking up in a table, database, or another data structure), and ascertaining as “determining”. In addition, “determining” can include considering receiving (for example, receiving information), transmitting (for example, transmitting information), inputting, outputting, and accessing (for example, accessing data in a memory) as “determining”. In addition, “determining” can include considering resolving, selecting, choosing, establishing, comparing, and the like as “determining”. That is, “determining” can include considering any operation as “determining”. In addition, “determining” may be read as “assuming”, “expecting”, “considering”, and the like.

The terms “connected” and “coupled” or variations thereof mean any direct or indirect connection or coupling between two or more elements, and can include a case where one or more intermediate elements are present between two elements “connected” or “coupled” to each other. The coupling or connection between elements may be physical, logical, or a combination thereof. For example, “connection” may be read as “access”. When used in the present disclosure, two elements can be considered to be “connected” or “coupled” to each other using at least one of one or more wires, cables, and printed electrical connections and using some non-limiting and non-inclusive examples, such as electromagnetic energy having wavelengths in a radio frequency domain, a microwave domain, and a light (both visible and invisible) domain.

The description “based on” used in the present disclosure does not mean “based only on” unless otherwise specified. In other words, the description “based on” means both “based only on” and “based at least on”.

Any reference to elements using designations such as “first” and “second” used in the present disclosure does not generally limit the quantity or order of the elements. These designations can be used in the present disclosure as a convenient method for distinguishing between two or more elements. Therefore, references to first and second elements do not mean that only two elements can be adopted or that the first element should precede the second element in any way.

When “include”, “including”, and variations thereof are used in the present disclosure, these terms are intended to be inclusive similarly to the term “comprising”. In addition, the term “or” used in the present disclosure is intended not to be an exclusive-OR.

In the present disclosure, in a case where articles, for example, a, an, and the in English, are added by translation, the present disclosure may include that nouns subsequent to these articles are plural.

In the present disclosure, the expression “A and B are different” may mean “A and B are different from each other”. In addition, the expression may mean that “A and B each are different from C”. Terms such as “separate” and “coupled” may be interpreted similarly to “different”.

The change rate search system of the present disclosure has the following configuration.

[1]A change rate search system for searching for a change rate, which is a rate at which people change their behavior in response to predetermined measures, to make a degree of congestion in a people's behavior area desirable under predetermined criteria, the system including: a simulation unit that sets a change rate for predetermined measures and simulates people's behavior when the predetermined measures are taken in a behavior area by using the set change rate; and a search unit that searches for a desirable change rate based on a degree of congestion obtained from simulation results by the simulation unit.

[2] The change rate search system according to [1], wherein the search unit searches for a desirable change rate based on a degree of congestion in a transportation means.

[3] The change rate search system according to [1] or [2], wherein the search unit searches for a desirable change rate by using an evaluation function based on a maximum value or a variation of degrees of congestion for a plurality of targets obtained from simulation results.

[4] The change rate search system according to any one of [1] to [3], wherein the search unit acquires information indicating a cost of the predetermined measures related to the simulation by the simulation unit and searches for a desirable change rate based on the cost as well.

[5] The change rate search system according to any one of [1] to [4], wherein, the simulation unit simulates a behavior of each person who changes their behavior at the set change rate when measures are received.

[6] The change rate search system according to any one of [1] to [5], wherein the simulation unit acquires information indicating a range in which the predetermined measures are taken, and simulates people's behavior when the predetermined measures are taken in the range.

[7] The change rate search system according to [6], wherein the simulation unit acquires, as the information indicating the range in which the predetermined measures are taken, information indicating a geographical range in which measures are taken.

### REFERENCE SIGNS LIST

10: change rate search system, 11: simulation unit, 12: search unit, 1001: processor, 1002: memory, 1003: storage, 1004: communication device, 1005: input device, 1006: output device, 1007: bus.

1. A change rate search system for searching for a change rate, which is a rate at which people change their behavior in response to predetermined measures, to make a degree of congestion in a people's behavior area desirable under predetermined criteria, the system comprising circuitry configured to:
set a change rate for predetermined measures and simulate people's behavior when the predetermined measures are taken in a behavior area by using the set change rate; and
search for a desirable change rate based on a degree of congestion obtained from simulation results.

2. The change rate search system according to claim 1,
wherein the circuitry searches for a desirable change rate based on a degree of congestion in a transportation means.

3. The change rate search system according to claim 1,
wherein the circuitry searches for a desirable change rate by using an evaluation function based on a maximum value or a variation of degrees of congestion for a plurality of targets obtained from the simulation results.

4. The change rate search system according to claim 1,
wherein the circuitry acquires information indicating a cost of the predetermined measures related to the simulation and searches for a desirable change rate based on the cost as well.

5. The change rate search system according to claim 1,
wherein, the circuitry simulates a behavior of each person who changes their behavior at the set change rate when measures are received.

6. The change rate search system according to claim 1,
wherein the circuitry acquires information indicating a range in which the predetermined measures are taken, and simulates people's behavior when the predetermined measures are taken in the range.

7. The change rate search system according to claim 6,
wherein the circuitry acquires, as the information indicating the range in which the predetermined measures are taken, information indicating a geographical range in which measures are taken.
